(19) United States
(12) Patent Application Publication
(10) Pub. No.: US 2018/0149323 A1
(43) Pub. Date: May 31, 2018

(54) Portable Fireplace Assembly

(71) Applicant: Della Goetz, Berkeley (CA)

(72) Inventor: Della Goetz, Berkeley (CA)

(21) Appl. No.: 15/365,187

(22) Filed: Nov. 30, 2016

(51) Int. Cl. F21S 10/04; F21V 23/00; F21V 14/02; F21V 14/08; F21V 23/06; A47B 81/00

(52) U.S. Cl. CPC F21S 10/046; F21V 23/001; F21V 14/02; F21W 2121/00; F21V 23/06; A47B 81/00; F21V 14/08

(57) ABSTRACT

A portable fireplace assembly includes a rack that may be positioned on a support surface. A facade is provided and the facade is structured to resemble a plurality of stacked logs. The facade is positioned on the rack. Thus, the facade simulates a fireplace. An illumination unit is rotatably coupled to the facade. The illumination unit emits light outwardly from the facade thereby facilitating the illumination unit to simulate a fire.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to fireplace devices and more particularly pertains to a new fireplace device for simulating a fire.

### BRIEF SUMMARY OF THE INVENTION

An embodiment of the disclosure meets the needs presented above by generally comprising a rack that may be positioned on a support surface. A facade is provided and the façade is structured to resemble a plurality of stacked logs. The facade is positioned on the rack. Thus, the facade simulates a fireplace. An illumination unit is rotatably coupled to the façade. The illumination unit emits light outwardly from the facade thereby facilitating the illumination unit to simulate a fire.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a portable fireplace assembly according to an embodiment of the disclosure.

FIG. 2 is a bottom view of an embodiment of the disclosure.

FIG. 3 is a top view of an embodiment of the disclosure.

FIG. 4 is a cross sectional view taken along line 4-4 of FIG. 3 of an embodiment of the disclosure.

FIG. 5 is a cross sectional view taken along line 5-5 of FIG. 4 of an embodiment of the disclosure.

### DETAILED DESCRIPTION OF THE INVENTION

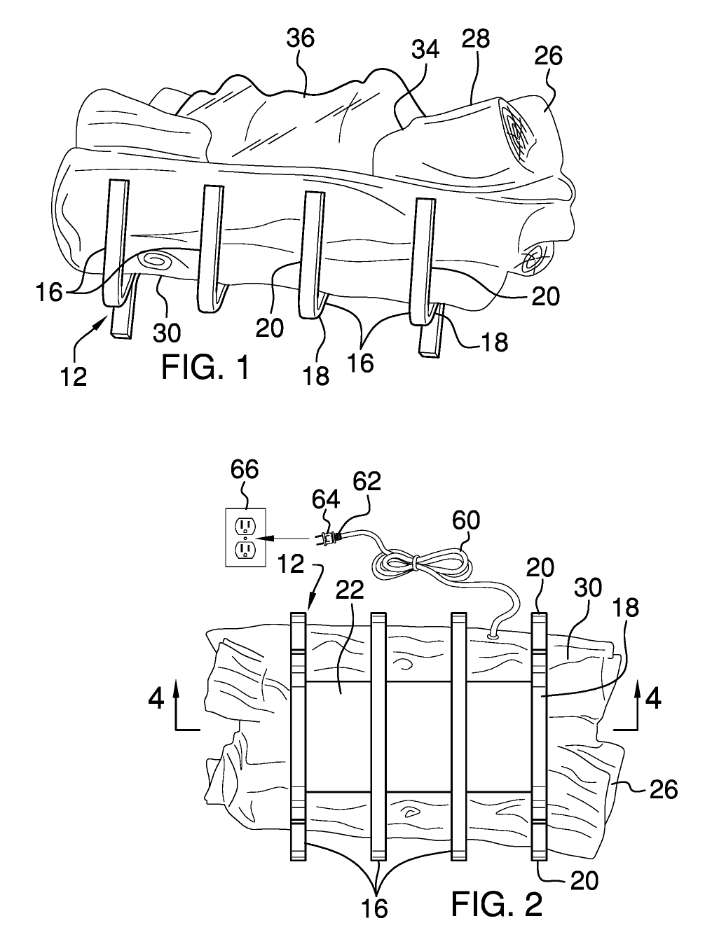

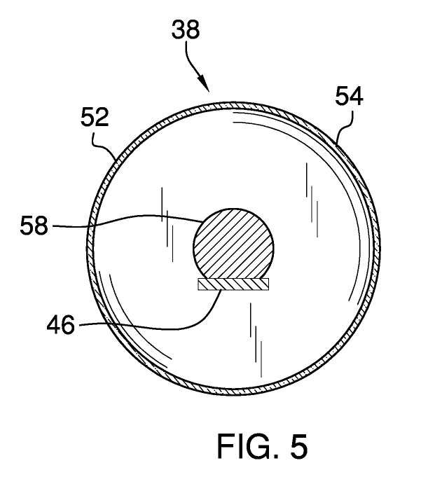

With reference now to the drawings, and in particular to FIGS. 1 through 5 thereof, a new fireplace device embodying the principles and concepts of an embodiment of the disclosure and generally designated by the reference numeral 10 will be described.

As best illustrated in FIGS. 1 through 5, the portable fireplace assembly 10 generally comprises a rack 12 that may be positioned on a support surface 14. The support surface 14 may be a floor or the like. The rack 12 comprises a plurality of supports 16. The supports 16 are spaced apart from each other. Each of the supports 16 has a central portion 18 and a pair of upright portions 20. The central portion 18 extends between the pair of upright portions 20.

A plate 22 is coupled to the central portion 18 corresponding to each of the supports 16. A plurality of legs 24 is provided. Each of the legs 24 is coupled to an associated one of the supports 16. Thus, each of the legs 24 supports 16 each of the supports 16 above a support surface 14.

A facade 26 is provided. The facade 26 is structured to resemble a plurality of stacked logs. The facade 26 is positioned on the rack 12. Thus, the facade 26 and the rack 12 simulate a fireplace.

The facade 26 has a top side 28, a bottom side 30 and an inner surface 32. The top side 28 has an opening 34 extending therethrough. The opening 34 is centrally positioned on the facade 26. A mesh 36 is coupled to the facade and the mesh 36 is aligned with the opening 34.

An illumination unit 38 is provided. The illumination unit 38 is rotatably coupled to the facade. The illumination unit 38 emits light outwardly from the facade 26. Thus, the illumination unit 38 simulates a fire.

The illumination unit 38 comprises a pair of stands 40. Each of the stands 40 coupled to the inside surface of the facade 26. Moreover, each of the stands 40 extends upwardly from the bottom side 30. Each of the stands 40 is spaced apart from each other on the inside surface of the facade 26. The pair of stands 40 includes a first stand 42 and a second stand 44. The first stand 42 has first arm 46 that is spaced from the bottom side 30 of the facade 26.

A motor 48 is provided. The motor 48 is coupled to the second stand 44 such that the motor 48 is spaced from the bottom side 30. The motor 48 may comprise an electric motor 48 or the like. A shaft 50 is coupled to the motor 48 and the motor 48 rotates the shaft 50 when the motor 48 is turned on.

A cylinder 52 is provided. The cylinder 52 is coupled to the shaft 50 having the cylinder 52 being horizontally oriented. The cylinder 52 has an outermost wall 54 and indicia 56 printed on the outermost wall 54. The indicia 56 comprise an image of flames. The cylinder 52 is comprised of a translucent material. The cylinder 52 is aligned with the opening 34 in the facade 26. The first arm 46 of the first stand 42 extends horizontally through an interior of the cylinder 52.

A light emitter 58 is provided. The light emitter 58 is coupled to the first arm 46 of the first stand 42. Moreover, the light emitter 58 is positioned within the cylinder 52. The light emitter 58 emits light through the outermost wall 54 of the cylinder 52. Thus, the light emitter 58 simulates flames when the light passes through the image of the flames.

A power cord 60 is provided and the power cord 60 is coupled to the facade 26. The power cord 60 is electrically coupled to each of the light emitter 58 and the motor 48. The power cord 60 has a distal end 62 with respect to the facade 26. A plug 64 is electrically coupled to the distal end 62. The plug 64 may be electrically coupled to a power source 66. The power source 66 may be an electrical outlet or the like.

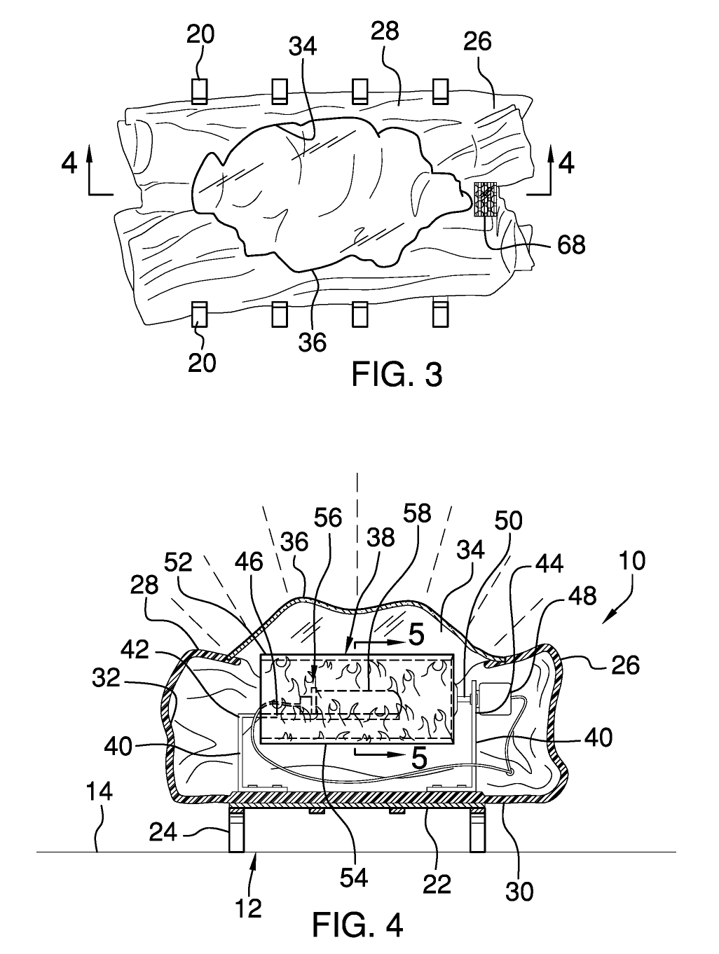

As shown in FIG. 3, a solar panel 68 may be included. The solar panel 68 may be positioned on the top side 28 of the facade 26. Thus, the solar panel 68 is exposed to sunlight. The solar panel 68 may be electrically coupled to the motor 48.

In use, the rack 12 is positioned in a selected area for simulating a burning fire. The illumination unit 38 is placed in the rack 12. The power cord 60 is plug 64 plugged into the power source. The motor 48 rotates the cylinder 52 and the light emitter 58 emits light through the cylinder 52. The light passing through the cylinder 52 emitter illuminates the mesh 36 material to simulate flames. Thus, the rack 12 and the illumination unit 38 facilitate enjoying the visual quality of a fire without an actual fire.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable fireplace assembly being configured to simulate burning logs, said assembly comprising:
a rack being configured to be positioned on a support surface;
a facade being structured to resemble a plurality of stacked logs, said facade being positioned on said rack wherein said facade is configured to simulate a fireplace, said facade having a top side, a bottom side and an inner surface, said top side having an opening extending therethrough, said opening being centrally positioned on said façade;
a mesh being coupled to said facade, said mesh being aligned with said opening, said mesh having a contoured exterior surface; and
an illumination unit being rotatably coupled to said facade wherein said illumination unit is configured to emit light outwardly from said facade thereby facilitating said illumination unit to simulate a fire, said illumination unit including a cylinder and a light emitter, said cylinder having an outermost wall, said outermost wall having indicia being printed thereon, said indicia comprising an image of flames, said cylinder being comprised of a translucent material, said cylinder being aligned with said opening in said facade, said light emitter being positioned within said cylinder wherein illumination of said light emitter projects said image of flames onto said mesh such that said image of flames is displayed on said mesh.

2. The assembly according to claim 1, wherein said rack comprises a plurality of supports, said supports being spaced apart from each other, each of said supports having a central portion and a pair of upright portions.

3. The assembly according to claim 2, further comprising a plate being coupled to said central portion corresponding to each of said supports.

4. The assembly according to claim 2, further comprising a plurality of legs, each of said legs being coupled to an associated one of said supports wherein each of said legs is configured to support each of said supports above the support surface.

5. (canceled)

6. (canceled)

7. The assembly according to claim 5, wherein said illumination unit comprises a pair of stands, each of said stands coupled to said inside surface of said facade, each of said stands extending upwardly from said bottom side, each of said stands being spaced apart from each other on said inside surface of said facade, said pair of stands including a first stand and a second stand, said first stand having a first arm being spaced from said bottom side.

8. The assembly according to claim 7, further comprising a motor being coupled to said second stand such that said motor is spaced from said bottom side.

9. The assembly according to claim 8, further comprising a shaft being coupled to said motor such that said motor rotates said shaft when said motor is turned on.

10. The assembly according to claim 9, further comprising cylinder being coupled to said shaft having said cylinder being horizontally oriented, said first arm of said first stand extending horizontally through an interior of said cylinder.

11. The assembly according to claim 10, further comprising said light emitter being coupled to said first arm of said first stand.

12. The assembly according to claim 10, further comprising a power cord being coupled to said facade, said power cord being electrically coupled to each of said light emitter and said motor, said power cord having a distal end with respect to said facade, said distal end having a plug being electrically coupled thereto wherein said plug is configured to be electrically coupled to a power source.

13. A portable fireplace assembly being configured to simulate burning logs, said assembly comprising:
a rack being configured to be positioned on a support surface, said rack comprising:
a plurality of supports, said supports being spaced apart from each other, each of said supports having a central portion and a pair of upright portions,
a plate being coupled to said central portion corresponding to each of said supports, and
a plurality of legs, each of said legs being coupled to an associated one of said supports wherein each of said legs is configured to support each of said supports above the support surface;
a facade being structured to resemble a plurality of stacked logs, said facade being positioned on said rack wherein said facade is configured to simulate a fireplace, said facade having a top side, a bottom side and an inner surface, said top side having an opening extending therethrough, said opening being centrally positioned on said facade;
a mesh being coupled to said facade, said mesh being aligned with said opening said mesh having a contoured exterior surface; and
an illumination unit being rotatably coupled to said facade wherein said illumination unit is configured to emit light outwardly from said facade thereby facilitating said illumination unit to simulate a fire, said illumination unit comprising:
a pair of stands, each of said stands coupled to said inside surface of said facade, each of said stands extending upwardly from said bottom side, each of said stands being spaced apart from each other on said inside surface of said facade, said pair of stands including a first stand and a second stand, said first stand having a first arm being spaced from said bottom side,
a motor being coupled to said second stand such that said motor is spaced from said bottom side,
a shaft being coupled to said motor such that said motor rotates said shaft when said motor is turned on,
a cylinder being coupled to said shaft having said cylinder being horizontally oriented, said cylinder having an outermost wall, said outermost wall having indicia being printed thereon, said indicia comprising an image of flames, said cylinder being comprised of a translucent material, said cylinder being aligned with said opening in said facade, said first arm of said first stand extending horizontally through an interior of said cylinder,
a light emitter being coupled to said first arm of said first stand such that said light emitter is positioned within said cylinder said light emitter being positioned within said cylinder wherein illumination of said light emitter projects said image of flames onto said mesh such that said image of flames is displayed on said mesh, and
a power cord being coupled to said facade, said power cord being electrically coupled to each of said light emitter and said motor, said power cord having a distal end with respect to said facade, said distal end having a plug being electrically coupled thereto wherein said plug is configured to be electrically coupled to a power source.
